(19) United States
(12) Patent Application Publication
(10) Pub. No.: US 2003/0097298 A1
(43) Pub. Date: May 22, 2003

(54) On-line bonus program

(76) Inventors: Martin Klimpl, Prague (CZ); Pavel Novak, Prague (CZ); Karel Slepicka, Prague (CZ); Jan Mikulec, Nove Jirny (CZ); Martin Durcak, Havirov (CZ); Petr Babicky, Prague (CZ); Michal Cupa, Prague (CZ); Jan Dobrovsky, Prague (CZ)

Correspondence Address: Robert E. Pershes, Esq., Becker & Poliakoff, P.A., 3111 Stirling Road, Fort Lauderdale, FL, 33312, US

(21) Appl. No.: 09/997,303

(22) Filed: Nov. 20, 2001

(51) Int. Cl. G06F 17/60

(52) U.S. Cl. 705/14; 705/39

(57) ABSTRACT

A bonus system that allows consumers to visit a merchant's facility either on the internet or to physically visit a merchant's facility to accumulate and redeem bonus points. In addition, the consumer can utilize and accumulate bonus points with several different merchants.

### BACKGROUND OF INVENTION

There is a strong need in commerce to provide bonuses as an additional benefit to consumers to encourage sales. Electronic commerce is growing rapidly as customers begin to accept shopping over the world wide web as an appealing alternative to physically going to each shop. However, there is a great deal of competition among merchants and price competition is extremely strong. This is especially true in the internet setting as customers can easily go from site to site to determine the best price for the merchandise they wish to purchase.

To attract customers and induce them to make a purchase, many merchants have utilized discount programs. These typically reduce the price of the goods and function primarily as an inducement based solely on the price of the merchandise. While it may result in a particular sale being made, it is not strong on bringing customers back to the original merchant for other purchases. When the discount is too great, profits may be adversely impacted and the increase in sales may not warrant the discount being given.

In addition to discounts, various other methods of inducement to the purchaser have been tried by merchants. These have ranged from coupons, to reward booklet discounts, or reward certificates, to cross-benefits between merchants.

The underlying problem with each of these systems however, is that they have a great deal of restrictions on the uses the consumer can make of the benefit being provided. While the specific benefit may be an inducement to one type of purchaser or consumer, it may be of no value at all to another consumer. Further, the redemption of the reward certificates are usually for items which the consumer neither wants nor is the consumer about to keep track of, if a large number of reward units are needed for the redemption to be obtained. The most common of these type programs have been linked to credit cards such as those offering frequent flyer benefits, or stamp programs where their accumulated stamps are collected and then sent in for redemption from a gift catalogue. What the consumer actually desires is a program that results in benefits that can readily be used for purchasers the consumer wishes to make, rather than being tied to a specific benefit or a specific merchant.

### BRIEF DESCRIPTION OF DRAWING

FIG. 1 is a block diagram showing the relationship of the Bonus System Provider with the merchant and the consumer.

FIG. 2 is a block diagram showing the transaction of the consumer who has established a consumer account with the Bonus System Provider, where no bonus points are utilized in the transaction by the consumer.

FIG. 3 is a block diagram showing the transaction of the consumer who has established a consumer account with the Bonus System Provider, using bonus points for the transaction.

FIG. 4 is a block diagram showing the transaction where two participating merchants are utilizing a special bonus program between themselves for the benefit of consumers.

### SUMMARY OF THE INVENTION

The objective of the present invention is to improve the method of providing benefits to customers utilizing e-commerce. This method allows merchants to offer consumer benefits or added value in the form of points. The merchant can offer these points both for on-line transactions or transactions at the store off-line. The consumer can accept the points indicated on the sales receipt or can use them instantly for a price discount. Typically the points will have a greater value if taken as points to be redeemed elsewhere rather than used for the instant price discount. The consumer opens an on-line account with the Bonus System Provider who maintains a listing for the consumer of the points that the consumer earns and has accumulated. The consumer can add points to the account by directly entering the account and entering the sales transaction points and verification number of the transaction, or the merchant can directly enter the points to the consumer's account using the merchant's computer system.

The bonus points accumulate in the consumer's account and the consumer can then utilize the bonus points in numerous ways. The value of the bonus points may be varied by the merchant participants, and can have a monetary value.

The consumer has the ability to access his account through the internet. As points accumulate, the consumer can redeem them for cash value or utilize them for purchases from both on-line and off-line merchant sources that participate in the program.

A merchant who participates in the program can give points to provide incentives, can redeem points against merchandise purchased and utilize points for promotional purposes. Since the easiest use of the program is for e-commerce transactions on the world wide web, on-line transactions receive the greatest benefit. However, the ability to link the program with off-line purchases makes it a practical and alluring tool for the consumer.

Merchants register with the program by opening an account through the Bonus System Provider platform and then they can offer bonus points to their customers. These bonus points can then be made available to consumers at the store for off-line sales and on the computer for on-line sales. When the merchant honors points by providing discounts or merchandise, the value of those points is added to that merchant's merchant account.

With each transaction, a unique transaction number is provided, enabling the issuance and redemption of bonus points to be traced. The participating merchant has flexibility in giving greater benefits for bonus point redemption for merchandise, at the merchant's expense, to stimulate sales. The consumer has the ability to utilize the bonus points as best meets the individual consumer's needs.

### DETAILED DESCRIPTION OF PREFERRED EMBODIMENT

The consumer today desires to obtain the best price and best value. Merchants use discounts and benefits to obtain sales and establish customer loyalty. Use of benefits has typically been by rewards such as discount programs, credit certificates, discount coupons and merchandise stamps. The most general programs provide discount stamps that the consumer uses with a gift catalogue towards the purchase of additional consumer goods. Unfortunately, this system does not work well as the goods the consumer may be looking for may not be contained in the catalogue. Further, as more and more consumers are getting comfortable with purchasing products by use of the world wide web, a greater amount of choice is desired. By linking their computer to the web through an internet service provider (ISP), the consumer can shop, compare prices, and make purchases all without leaving home. This invention promotes the ease of internet shopping, with a flexible reward system that uniquely can work for both on-line and off-line purchases, and is independent of the particular merchant. At the same time, the system allows merchants to co-partner together to give awards to consumers who desire to participate in a selective program. With the program basics applicable to goods of every nature and various types of rewards for the consumer, the costs for the basic program are less than individual systems that a merchant must operate solely for its own sales.

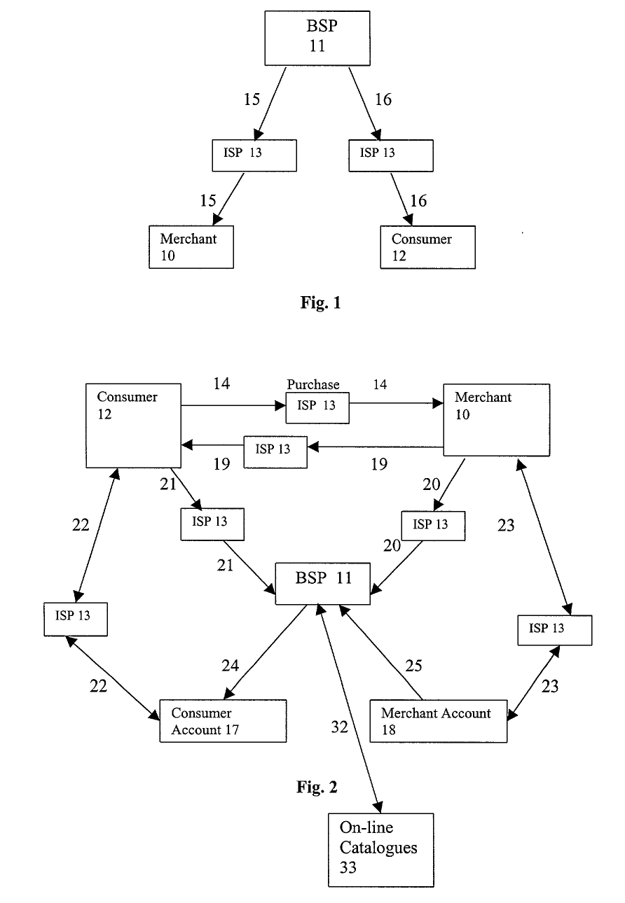

In general terms, looking at FIG. 1, a consumer 12 opens a consumer account with the Bonus System Provider (BSP) 11 through use of an internet service provider (ISP) 13. The Bonus System Provider 11 provides 16 the consumer 12 with an account number and password to allow the consumer 12 to access its consumer account to determine if bonus points have been credited to the account or used for purchases. FIG. 1 also shows the merchant 10 opening 15 a merchant account with the Bonus System Provider 11, which in the preferred mode is done by using an ISP 13 to connect over the internet. The information between consumer 12, Bonus System Provider 11 and merchant 10, and merchant 10 to merchant 10 can be transferred by the internet which provides quick, efficient, updated and readily accessible information for all participants. Other rapid means of communication are also within the scope of this invention, including infrared instant messaging and global systems for mobile communication networks accessed via short message service. These systems can be used in place of or in conjunction with the internet service provider to transfer information between the participants.

FIG. 2 is a block diagram showing a transaction 14 by a consumer 12 with a merchant 10 where both consumer 12 and merchant 10 have accounts, consumer account 17 and merchant account 18, with the Bonus System Provider 11. In this transaction 14, the consumer 12 does not utilize any bonus points and the bonus points acquired from the transaction 14 are deducted 25 from the merchant account 18 and credited 24 to the consumer account 17.

The consumer 12, when establishing the consumer account 17 with the Bonus System Provider 11, is given an account number and individualized password. This allows the consumer 12 in any transaction 14 to identify the consumer account 17 when making a purchase or utilizing a service. At FIG. 2 the consumer 12 can make a transaction 14 at the merchant's facility or through the internet using an ISP 13. When the merchant 10 enters the transaction 14, the merchant 10 notifies the consumer 12 and notifies 20 the BSP 11 of the bonus points that will be credited 24 to the consumer account 17 when completing the transaction 14. Upon completion of the transaction 14, the merchant 10 provides the consumer 12 with notification 19, either on the sales receipt or on the internet through an ISP 13 by confirmation e-mail, containing a vendor number, a consumer account number, a transaction confirmation number, total sales amount and the number of bonus points earned by the consumer 12 which have been credited 24 to the consumer account 17. At the same time, this information is transmitted 20 by internet through an ISP 13 to the Bonus System Provider 11 to deduct 25 bonus points from the merchant account and credit 24 them to the consumer account 17. The consumer 12 can contact 21 the Bonus System Provider 11 on the internet through an ISP 13 to verify 22 the information contained in the consumer account 17. The merchant 10 can also verify 23 the information contained in the merchant account 18. To obtain bonus points, the consumer 12 independently enters the information of the transaction 14 with the merchant 10 through ISP 13 via internet, then the consumer account 17 will be automatically updated by the Bonus System Provider 11. The Bonus System Provider 11 correlates the information received from both the merchant 10 and consumer 12 to insure that the consumer 12 receives the proper credit of bonus points for the transaction 14 and that the credit of points is not duplicated or not provided by the merchant 10. This can be accomplished by numerous methods from independent audit to assignment of unique transaction numbers by the Bonus System Provider 11 to the merchant 10 for the particular transaction 14.

The consumer 12 can allow the bonus points to accumulate in the consumer account 17 and utilize the bonus points, in the preferred mode, being credit for all or part of a purchase for goods.

The consumer 12 uniquely in this system can have bonus points applied to the cost of goods or services the consumer 12 typically utilizes on an ongoing basis. An example of such type of arrangement would be the consumer 12 who travels periodically and utilizes cell phone services. The bonus points earned from the air travel can be utilized as credits against the cell phone service provider's charges. Further, the bonus points earned for the cell phone services can be applied to the cell phone service provider's charges. With the air travel provider and the cell service provider both having accounts with the Bonus System Provider 11, this entire transaction can be done automatically for the consumer 12. The consumer 12 need only check its account with the Bonus System Provider 11 periodically to verify the status of the consumer account 17 and the credits being received. With the wide spread type of merchants 10 available for the consumer 12 to select from, the consumer 12 establishes the crediting or debiting relationship as desired and as best fits the consumer's lifestyle.

The consumer 12 can also utilize its credits at the time it makes a purchase from a merchant 10. The consumer 12 can apply the bonus points provided by the merchant 10 for an immediate discount at time of purchase, can utilize accumulated bonus points held in the consumer account 17 to increase the discount or, if sufficient bonus points are available to the consumer 12, to obtain the purchase without payment. The consumer 12, at the merchant 10 location, can have the merchant 10 contact the Bonus System Provider 11 and, with the consumer's account number and consumer's password key to the consumer account 17, utilize the appropriate number of bonus points at the time of purchase. The consumer 12 can also contact the merchant 10 through the internet and, if utilizing the consumer's accumulated bonus points, confirm the transaction 14 with the Bonus System Provider 11, transfer the appropriate bonus points from the consumer account 17, thereby allowing the merchant 10 to complete the transaction 14 with the consumer 12.

In addition, the consumer 12 can contact 21 the Bonus System Provider 11 directly for the purpose of acquiring goods or services from vendors and merchants 10 who have agreements with the Bonus System Provider 11 to provide these services or products through the Bonus System Provider 11. This feature makes the Bonus System Provider 11 site an electronic shopping mall which the consumer 12 accesses via an ISP 13 and where the consumer 12 can comparative shop and make purchases 32 from the electronic catalogue 33. The Bonus System Provider 11 can also contract with merchants 10 to provide special programs, multiple bonus points or other incentives which come from non-participating merchants.

The Bonus System Provider 11 performs several functions. The Bonus System Provider 11 acts as a clearing house and reconciles transactions 14 entered by the consumer 12 and those entered by the merchant 10. The Bonus System Provider 11 opens all accounts, keeps the accounts for both consumer 12 and merchant 10, and contracts for products, services and marketing promotions from merchants 10 desiring to provide goods and services. The Bonus System Provider 11 provides access to the public for all goods and services being made available with information as to the bonus points being provided in connection with the particular transaction 14. The cash value for redemption of bonus points can be adjusted to make it more advantageous to the consumer 12 to utilize the bonus points against further purchases. This promotes the consumer 12 to become a member by opening a consumer account 17 and to accumulate bonus points for future purchases. Since the bonus points are not tied to a particular merchant 10 or the particular benefit that merchant 10 can provide, consumers 12 are induced to open a consumer accounts 17 to utilize the bonus points in the most advantageous fashion.

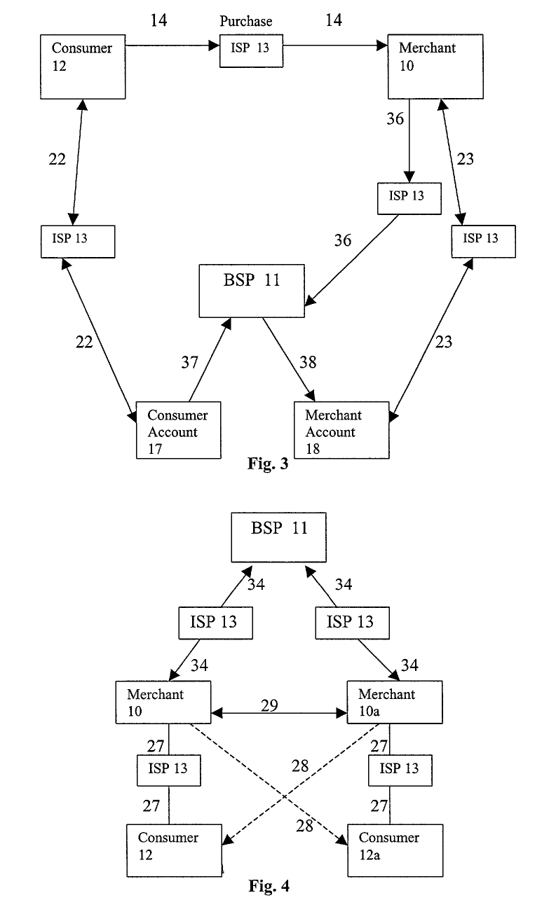

In FIG. 3, we have the consumer 12 making a purchase from a merchant 10 on the internet using an ISP 13. The consumer 12 utilizes his bonus points for the transaction. The merchant 10 can verify 36 the bonus point usage with the Bonus System Provider 11 resulting in the bonus points being credited 38 to the merchant account 18. The consumer account 17 is charged 37 the bonus points. The consumer 12 can verify 22 his consumer account 17 to insure that the proper debit has been taken for the transaction 14, while the merchant 10 can verify 23 that the proper credit has been obtained in the merchant account 18.

The Bonus System Provider 11, as seen in FIG. 3, provides the needed bonus points to the consumer 12 when the consumer 12 elects to have the accumulated bonus points applied to a transaction 14. The consumer 12 makes the purchase from a merchant 10 applying the bonus points to offset all or part of the purchase price. The merchant 10 can contact the Bonus System Provider 11 and, using the consumer's account number and password, apply the appropriate bonus points to the transaction 14.

In FIG. 4, the merchant 10 contracts 34 with the Bonus System Provider 11 to do promotional agreements 29 with other merchants 10 for joint programs. When the consumers 12 and 12a make a purchase 27 with merchants 10 and 10a, the consumer 12 or 12a can obtain corresponding benefits 28 from the other participating merchants, 10 or 10a.

The foregoing is a full description of the preferred embodiment of the invention, however it should be evident that numerous variations, modifications, alternatives and equivalents may be made to this method and system and within the appended claims without departing from the spirit and intended scope of the invention.

We claim:

1. A method for providing benefits to consumers comprising
a. organizing a Bonus System Provider to administer operations;
b. activating an on-line consumer account with said Bonus System Provider;
c. activating an on-line merchant account with said Bonus System Provider;
d. providing bonus points to participating consumers for purchases from participating merchants;
e. providing credit or debit to participating merchants for purchases from participating consumers.

2. The method of claim 1 wherein the Bonus System Provider administers both the consumer account and the merchant account.

3. The method of claim 1 wherein the consumer makes purchases at the merchant's facility.

4. The method of claim 1 wherein the consumer makes purchases at the merchant's web site.

5. The method of claim 1 wherein the consumer makes purchases at the Bonus System Provider web site.

6. The method of claim 1 wherein the consumer utilizes their accumulated bonus points at a participating merchant that is not the same as the merchant who provided the bonus points.

7. The method of claim 1 wherein the consumer accumulates bonus points.

8. The method of claim 1 wherein the consumer utilizes their accumulated bonus points to reduce the purchase price of products from participating merchants.

9. The method of claim 1 wherein the consumer utilizes their accumulated bonus points to reduce the purchase price of services from participating merchants.

10. The method of claim 1 wherein the consumer utilizes their accumulated bonus points to purchase products from participating merchants.

11. The method of claim 1 wherein the consumer utilizes their accumulated bonus points to purchase services from participating merchants

12. A method for providing benefits to consumers comprising
a. organizing a Bonus System Provider to administer operations;
b. activating an on-line consumer account with said Bonus System Provider;
c. activating an on-line merchant account with said Bonus System Provider;
d. providing bonus points to participating consumers for purchases from participating merchants at the merchant's web site and at the merchant's place of business;
e. providing credit or debit to participating merchants for purchases from participating consumers.

13. A method for providing benefits to consumers comprising
a. organizing a Bonus System Provider to administer operations;
b. activating an on-line consumer account with said Bonus System Provider;
c. activating an on-line merchant account with said Bonus System Provider;
d. providing bonus points to participating consumers for purchases from participating merchants;
e. providing credit or debit to participating merchants for purchases from participating consumers, wherein the consumer utilizes their accumulated bonus points at a participating merchant that is not the same as the merchant who provided the bonus points.
